(19) United States
(12) Patent Application Publication
(10) Pub. No.: US 2026/0285308 A1
(43) Pub. Date: Sep. 24, 2026

(54) LASER-BASED LANE INDICATION

(71) Applicant: Ford Global Technologies, LLC, Dearborn, MI (US)

(72) Inventors: Alan Gonzalez, Mexico City/CDMX (MX); Sandra Gutierrez Hinojosa, Mexico City (MX); Netsaualkoyotl Romualdo, Mexico City (MX)

(73) Assignee: Ford Global Technologies, LLC, Dearborn, MI (US)

(21) Appl. No.: 19/086,318

(22) Filed: Mar. 21, 2025

(51) Int. Cl. B60W 30/16; B60W 50/00

(52) U.S. Cl. CPC B60W 30/16; B60W 50/0097; B60W 2552/53

(57) ABSTRACT

A prediction is output, based on data from a sensor in a vehicle, that visibility of a lane boundary of a travel surface is impaired. In response to the prediction, a laser is actuated to indicate the lane boundary on the travel surface.

### BACKGROUND

Ground vehicles can operate under a variety of environmental conditions that can affect operation of the vehicle, such as an amount of moisture, rain, snow, slush, etc., on the ground surface, a humidity level, an amount of ambient light, etc. Vehicle sensors can be affected by environmental conditions. For example, optical or visible light spectrum cameras may have difficulty “seeing” under conditions such as fog, snow, etc.

### BRIEF DESCRIPTION OF THE DRAWINGS

FIG. 1 is a diagram of an example vehicle system.

FIGS. 2A-2D illustrate example scenarios of a vehicle on a travel surface projecting lane indicia.

FIG. 3 is a diagram of an example process for actuating lasers to output lane indicia such as lane indicating lines and/or symbols on a travel surface such as a road.

### DESCRIPTION

### Introduction

Described herein are techniques for a vehicle using one or more lasers to project lane indicia on a travel surface. Typically, the travel surface is a road such as a street or highway. The vehicle can include a computer that receives data to detect travel conditions in which a vehicle operator may be unable to discern land boundaries or markings on the travel surface. In such a situation, the vehicle computer can provide the lane indicia such as lines or symbols to support operation of the vehicle.

A system can comprise a processor and a memory, the memory storing instructions executable by the processor, including instructions to output a prediction, based on data from a sensor in a vehicle, that visibility of a lane boundary of a travel surface is impaired; and in response to the prediction, actuate a laser to indicate the lane boundary on the travel surface.

The instructions can include instructions to determine the lane boundary based on thermal image data, a determined width of a lane on the travel surface, a width of the vehicle, and/or a geo-location of the vehicle. Determining the lane boundary based on the geo-location of the vehicle can include determining a number of lanes of the travel surface, respective directions of travel of lanes of the travel surface, and/or historical traffic data for the location.

The data from a sensor in a vehicle can be output from a fog sensor or a visible light spectrum camera.

The instructions to actuate the laser can include instructions to indicate a second lane boundary on the travel surface and/or to project a symbol on the travel surface forward of the vehicle. The symbol can indicate an upcoming curve of the travel surface, an object on the travel surface, and/or a recommended distance for the vehicle to follow a second vehicle.

The laser can be mounted to project light forward of the vehicle. A second laser can be mounted to project light rearward of the vehicle, and the instructions can further include instructions to actuate the second laser to indicate the lane boundary on the travel surface. The instructions can include instructions to actuate the laser to output light detectable from a second vehicle.

A method comprises outputting a prediction, based on data from a sensor in a vehicle, that visibility of a lane boundary of a travel surface is impaired; and in response to the prediction, actuating a laser to indicate the lane boundary on the travel surface.

The lane boundary can be determined based on thermal image data, a determined width of a lane on the travel surface, a width of the vehicle, and/or a geo-location of the vehicle. based on thermal image data, a determined width of a lane on the travel surface, a width of the vehicle, and/or a geo-location of the vehicle. Determining the lane boundary based on the geo-location of the vehicle can include determining a number of lanes of the travel surface, respective directions of travel of lanes of the travel surface, and/or historical traffic data for the location.

The data from a sensor in a vehicle can be output from a fog sensor or a visible light spectrum camera.

A second lane boundary can be indicated on the travel surface and/or to project a symbol on the travel surface forward of the vehicle. The symbol can indicate an upcoming curve of the travel surface, an object on the travel surface, and/or a recommended distance for the vehicle to follow a second vehicle.

The laser can be mounted to project light forward of the vehicle. A second laser can be mounted to project light rearward of the vehicle, and the instructions can further include instructions to actuate the second laser to indicate the lane boundary on the travel surface. The laser can be arranged to output light detectable from a second vehicle.

### Example System

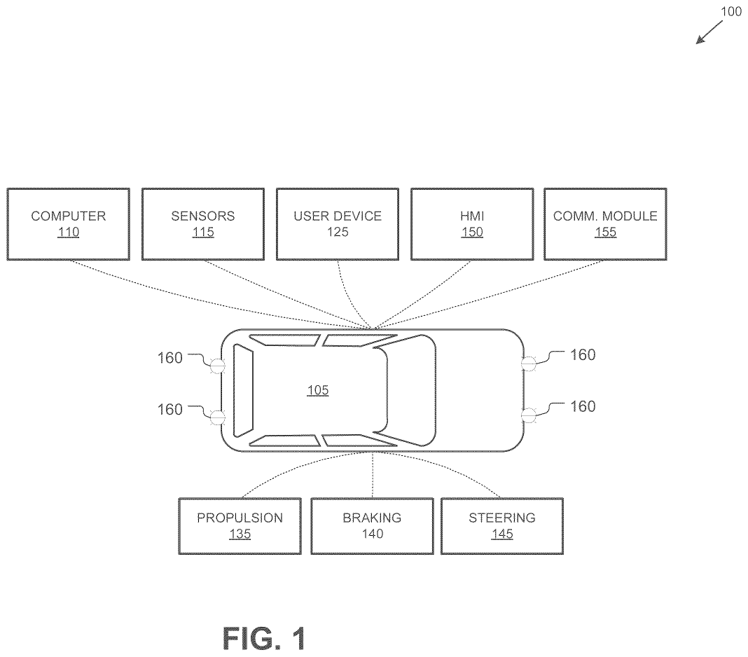

FIG. 1 illustrates an example system 100 for a vehicle 105. A computer 110 in the vehicle 105 is programmed to receive data collected from one or more sensors 115, and other sensors (not shown), to provide certain vehicle data. For example, one or more camera sensors 115 may provide image data from a camera's field of view. A user device with a touch screen may be disposed in vehicle 105. Example user devices include a vehicle computer 110 communicatively coupled (e.g., via a vehicle network) to an HMI 150 with a touch screen installed as part of a vehicle 105 infotainment system, or a hand-held portable computing device 125 with a touch screen. While all modern original equipment manufacturers (OEMs) of passenger vehicles currently warn drivers against using a handheld portable device while driving a vehicle due to safety concerns, it is expected that technology and the regulatory framework may evolve in the future to where such an activity becomes safe and permissible.

Vehicle data may further include a location of the vehicle 105, data about an environment around a vehicle, data about an object outside the vehicle such as another vehicle, etc. A vehicle location may be provided in a conventional form such as by geo-coordinates such as latitude and longitude coordinates obtained via a navigation system that uses a global navigation satellite system (GNSS) such as the Global Positioning System (GPS) system. Further examples of vehicle data can include measurements of vehicle systems and components (e.g., a vehicle speed or velocity, a level of fuel in a fuel tank, an amount of available electric charge, etc.).

A computer 110 can be provided to control one or more vehicle operations including steering, acceleration, speed control, and/or braking. Accordingly, system 100 is shown comprising vehicle 105 which may include Driver Assistance System (DAS) features. A computer 110 (e.g., one or more vehicle 105 electronic control units, i.e., ECUs) can be configured to operate the vehicle 105 independently of operation by an occupant with regard to certain features. A computer 110 may be programmed to provide a driver assistance system (DAS) such as cruise control (where the computer maintains vehicle speed according to a set speed), adaptive cruise control (ACC) (where the computer maintains the vehicle speed according to a set speed but can adjust vehicle speed based on detected distances and/or speeds of other vehicles), and/or hands-free driving. For example, the computer 110 could provide hand-free driving in combination with ACC such that the computer 110 controls steering, braking and acceleration. In another example, the computer 110 could provide ACC and require hands-on operation. The computer 110 may be programmed to operate a powertrain propulsion system 135, a braking system 140, a steering system 145, a device screen that displays a Human Machine Interface (HMI) 150, and/or other vehicle systems.

A computer 110 is generally programmed for communications on a vehicle network (not shown), for example, a conventional vehicle communications bus such as a Controller Area Network (CAN) bus, a Local Interconnect Network (LIN) bus, etc., and/or other wired and/or wireless technologies such as Bluetooth®, Wi-Fi®, Ethernet, etc. via the network, bus, and/or other wired or wireless mechanisms (e.g., a wired or wireless local area network in the vehicle 105), the computer 110 may transmit messages to various devices in the vehicle 105 and/or receive messages from the various devices such as sensors 115, controllers and actuators (not shown), etc.

Alternatively or additionally, for example, in cases where the computer 110 actually comprises multiple devices, the vehicle network may be used for communications between devices represented as the computer 110 in this disclosure. For example, the computer 110 can be a generic computer with a processor and memory as described above, and/or may include a dedicated electronic circuit including an application specific integrated circuit (ASIC) that is manufactured for a particular operation such as an ASIC for processing sensor data and/or communicating the sensor data. In another example, the computer 110 may include a Field-Programmable Gate Array (FPGA), which is an integrated circuit manufactured to be configurable by a user. Typically, a hardware description language such as Very high speed integrated circuit Hardware Description Language (VHDL) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming (e.g. stored in a memory electrically connected to the FPGA circuit). In some examples, a combination of processor(s), ASIC(s), and/or FPGA circuits may be included in computer 110.

In addition, the computer 110 may be programmed for communicating with a network and/or devices outside of the vehicle (not shown), which may include various wired and/or wireless networking technologies such as cellular, Bluetooth®, Bluetooth® Low Energy (BLE), wired and/or wireless packet networks, etc.

The memory can be of any type, for example hard disk drives, solid state drives, servers, or any volatile or non-volatile media. The memory can store the collected data sent from the sensors 115. The memory can be a separate device from the computer 110, and the computer 110 can retrieve data stored in the memory via a network in the vehicle 105, for example over a CAN bus, a wireless network, etc. Alternatively or additionally, the memory can be part of the computer 110 (e.g., as a memory of the computer 110).

Sensors 115 can include a variety of devices. For example, various controllers in a vehicle 105 may operate as sensors 115 to provide data via the vehicle network or bus such as data relating to vehicle speed, acceleration, location, subsystem and/or component status, etc. Further, other sensors 115 could include cameras, motion detectors, etc. (i.e., sensors 115 may provide data for evaluating a status of a component, evaluating a slope of a roadway, etc.). The sensors 115 could, without limitation, also include short range radar, long range radar, light detection and ranging (LIDAR), ultrasonic transducers, and the like. Cameras can include optical cameras (e.g., in the visible spectrum), and/or other kinds of cameras such as time-of-flight, infrared, etc.

In one example, the vehicle 105 includes one or more thermal camera sensors 115. Thermal cameras, one type being far-infrared cameras, can be used to detect animals in both low light and light-obscured conditions. Thermal cameras provide images in various lighting conditions (night, sun glare, etc.) and weather conditions (fog, rain, etc.) that can be superior to the contrast provided by cameras limited to the visible light region.

Collected data can include a variety of data collected in a vehicle 105. Examples of collected data are provided above. Data are generally collected using one or more sensors 115, and may additionally include data calculated therefrom in the computer 110. In general, collected data may include any data gathered by the sensors 115 and/or computed from such data.

The vehicle 105 can include a plurality of vehicle components. In this context, a vehicle component may include one or more hardware components adapted to perform a mechanical function or operation—such as moving the vehicle 105, slowing or stopping the vehicle 105, steering the vehicle 105, etc. Non-limiting examples of components include a powertrain propulsion component 135 (that includes, e.g., an internal combustion engine and/or electric motor, etc.), a transmission component, a steering assembly (e.g., that may include one or more of a steering wheel, a steering rack, etc.), a brake component 140, a park assist component, an adaptive cruise control component, an adaptive steering component 145, a movable seat, and the like. Components can include computing devices such as electronic control units (ECUs) or the like and/or computing devices such as described above with respect to the computer 110, and that likewise communicate via a vehicle network.

The HMI 150 typically includes one or more of a display, a touchscreen display, a microphone, a speaker, etc. The user can provide input to devices such as the computer 110 via the HMI 150. The HMI 150 can communicate with the computer 110 via the vehicle network; for example, the HMI 150 can send a message including the user input provided via a touchscreen, microphone, a camera that captures a gesture, etc., to a computer 110, and/or can display output such as via a screen, speaker, etc.

In addition, the vehicle computer 110 may be configured for communicating via a vehicle-to-vehicle communication module 155 or interface with devices outside of the vehicle 105 (e.g., through a vehicle-to-vehicle (V2V) or vehicle-to-infrastructure (V2X) wireless communications (cellular and/or short-range radio communications, etc.) to another vehicle, and/or to a remote server computer (typically via direct radio frequency communications)). The communications module 155 could include one or more mechanisms, such as a transceiver, by which the computers of vehicles may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the communications module 155 include cellular, Bluetooth, IEEE 802.11, dedicated short range communications (DSRC), cellular V2X (CV2X), and/or wide area networks (WAN), including the Internet, providing data communication services. The label “V2X” is used herein for communications that may be vehicle-to-vehicle (V2V) and/or vehicle-to-infrastructure (V2I), and that may be provided by communication module 155 according to any suitable short-range communications mechanism (e.g., DSRC, cellular, or the like).

The vehicle 105 includes one or more lasers 160, that is, any suitable device that emits visible light, and that may project a pattern, by a process of optical amplification that includes stimulated emission of electromagnetic radiation. The computer 110 may control or direct a pattern or patterns of light emissions from the one or more lasers 160, as described further below.

### Implementation Examples

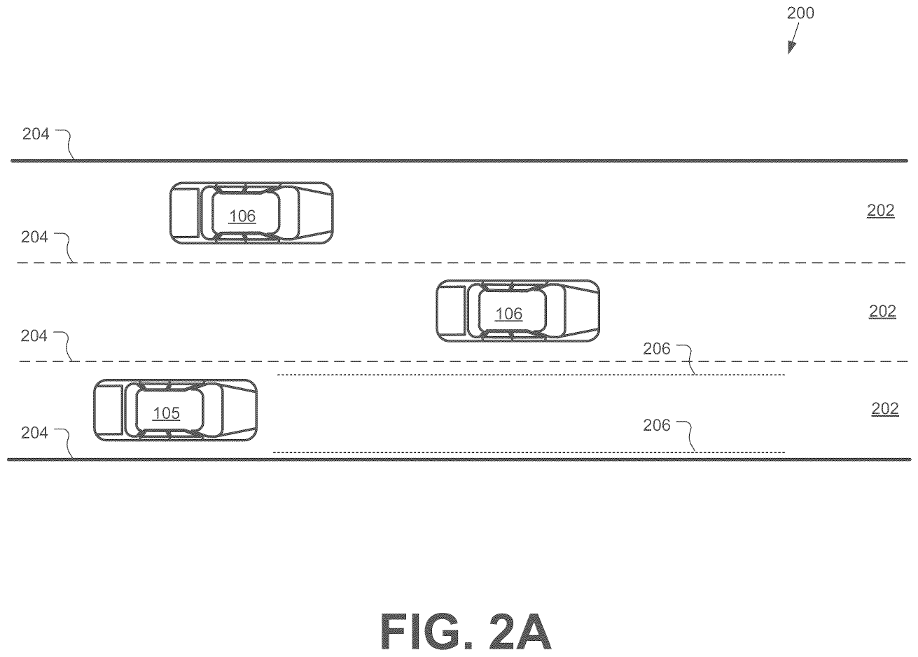

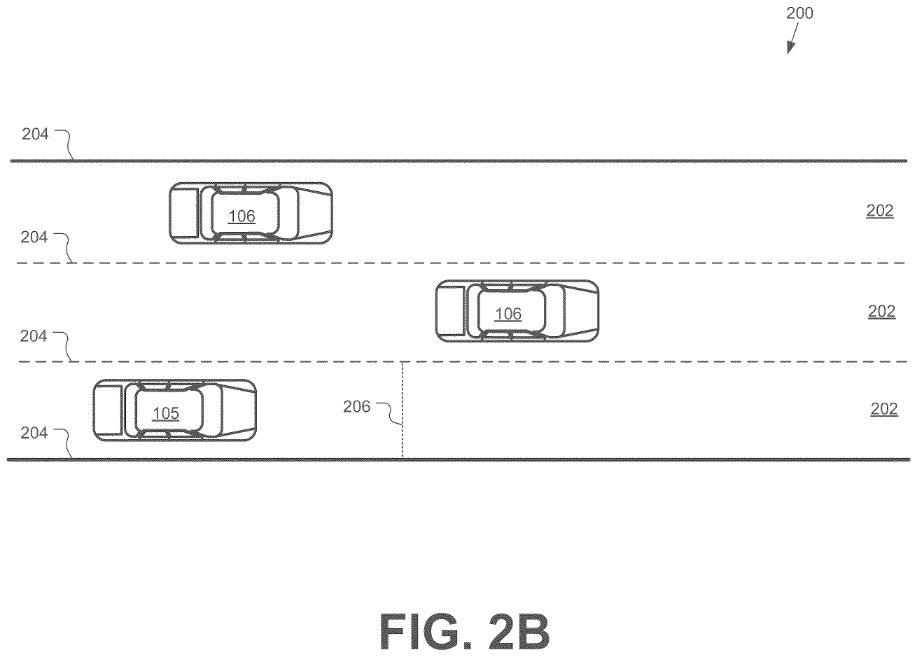

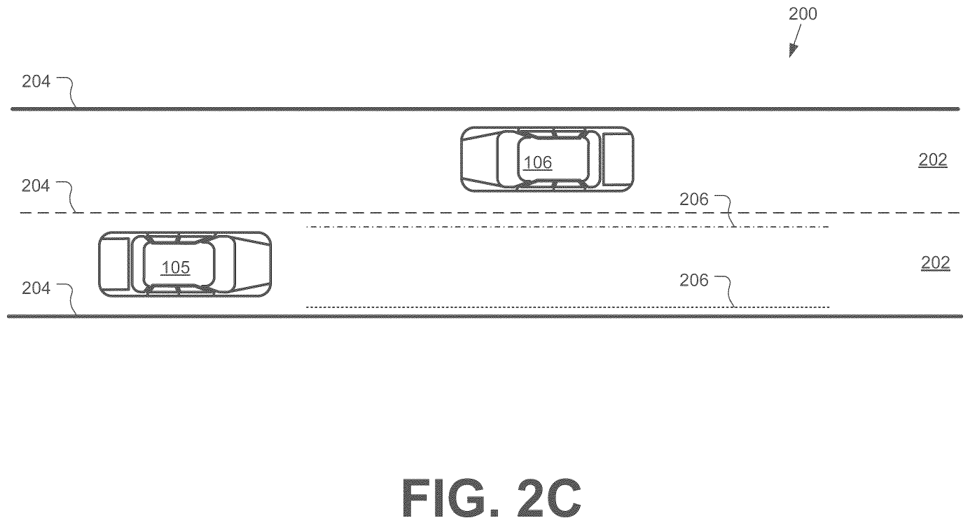

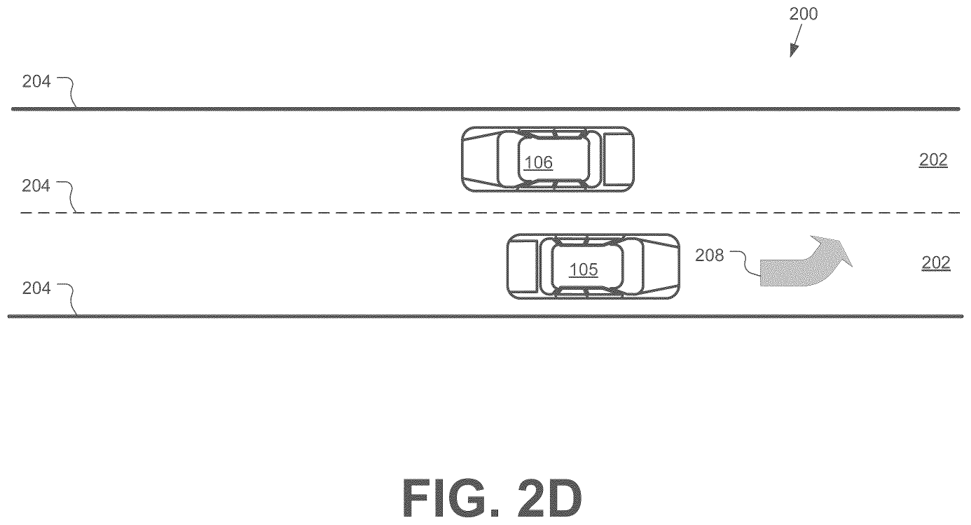

Referring now to FIGS. 1 and 2A-2D, the vehicle computer 110 memory typically stores instructions to output a prediction, based on data from a sensor 115 in a vehicle 105, that visibility of a lane boundary 204 of a travel surface such as a road 200 is impaired; and in response to the prediction, actuate one or more lasers 160 to indicate the lane boundary 204 on the travel surface. Typically, the laser or lasers 160 is/are mounted to project light forward of the vehicle 105. Alternatively or additionally, one or more lasers 160 could be mounted to project light rearward of the vehicle 105, the computer 110 including instructions to actuate the additional rearward-directed laser(s) to indicate a lane boundary 204 on the travel surface.

FIG. 2A illustrates an example road 200 with three lanes 202, on which travel an ego vehicle 105 and other vehicles 106. In this example, vehicles 105, 106 in all three lanes 202 move in a same direction of travel. The vehicle 105 projects at least one lane line 206, and typically, as shown in FIG. 2A, projects two lane lines 206 to indicate respective left and right lane boundaries 204. The two lane lines 206 can be projected to be parallel to one another, extending in a direction of travel of the vehicle 105. As seen in FIG. 2A, the lane lines 206 are straight, but they could be curved for a curved lane 202. The distance between the lane lines 206 can be determined by suitable factors, such as regulations specifying a width of a road lane, a width of a vehicle 105 (possibly with an additional distance added to provide a buffer or cushion), etc.

FIG. 2B illustrates the road 200 with the vehicle 105 projecting a lane line 206 forward of the vehicle 105 indicating a width of a current lane 202 in which the vehicle 105 is traveling. The lane line 206 is thus perpendicular to the direction of travel and maybe parallel to a lateral axis of the vehicle 105, where a longitudinal axis of the vehicle 105 is aligned with the direction of travel.

FIG. 2C illustrates the road 200 with two lanes 202 having directions of travel opposite one another. To indicate that vehicles 106 in an adjacent lane 202 are traveling in an opposing direction, a projected lane line 206 indicating the boundary 204 between a current lane 202 of the eagle vehicle 105 and the adjacent lane 202 can have a different pattern than other one or more projected lane lines 206. For example, as seen in FIG. 2C, a lane line 206 projected on a left side of the vehicle 105 has a different pattern from the lane line 206 on the right side of the vehicle 105. The lane line 206 projected on the left side of the vehicle 105 could thus indicate that traffic in an adjacent lane 202 is in an opposing direction.

FIG. 2D illustrates the road 200 with the vehicle 105 travelling in a lane 202, and projecting on the road surface 200 in the lane 202A symbol 208. The symbol 208 in this example is an arrow pointing to the left, indicating that, although an upcoming curve in the lane 202 may not yet be viewable or perceivable in the vehicle 105, a curve or turn is upcoming. Many other example symbols are possible, such as words (for example, “merge,” “exit,” or a word in combination with another symbol such as an arrow, etc.), letters, icons, etc. In addition or alternatively to indicating an upcoming curve of the travel surface, a symbol 208 could indicate an object on the travel surface, or a recommended distance for the vehicle 105 to follow a second vehicle 106.

It is to be understood that various lane lines 206 and symbols 208 as illustrated in the Figures and/or discussed herein could be output from laser(s) 160 in various combinations. For example, the lane line 206 of FIG. 2B, perpendicular to the lateral axis of the vehicle 105, could be used in combination with lane lines 206 such as shown in FIG. 2A, indicating boundaries 204 for the Vehicle 105 to travel in lane 202. Alternatively or additionally, a symbol 208 could be projected in combination with lane lines 206 such as shown in FIG. 2A-2C.

In examples, the sensor 115 is a thermal camera, and the computer 110 can determine a lane boundary 204 based on thermal image data. For example, a suitable image or pattern recognition algorithm could be used to interpret image data such as thermal image data to identify lane lines or other markings on a road 200 to indicate one or more lane boundaries 204. Alternative or additionally, other types of sensors 115 could be used, such as output from a fog sensor or a visible light spectrum camera.

The computer 110 in examples can determine a lane boundary 204 based on a determined width of a lane on a travel surface such as a road 200. For example, a vehicle 105 could include a location sensor 115, for example, a sensor 115 that specifies a location, that is, a geo-location, of a vehicle. For example, a geo-location can be specified according to the Global Positioning System (GPS). The vehicle 105 location could then be used to retrieve map data (e.g., from a memory of the computer 110) specifying a width of a road 200 and/or lanes 202 at the location.

Further, location data could be used in conjunction with data from a thermal camera sensor 115. For example, map data for a current location of the vehicle 105 could be retrieved and used to determine a number of lanes of a travel service such as a road on which the vehicle 105 is currently traveling. Thermal image data could be used to determine edges of a road 200, and then a number of lanes 202 at the location could be determined from map data and used to determine a width of a lane 202 (for example, by dividing a width of the road 200 determined according to a distance between the edges by the number of lanes 202).

Moreover, the computer 110 may determine a lane boundary 204 based on a geo-location of the vehicle 105 in additional or alternative ways. In one example, determining a lane boundary 204 based on a location of the vehicle 105 can include the computer 110 determining the lane boundary 204 from sensor 115 data such as thermal image data, and also determining directions of travel of lanes 202 on a road 200 based on the location of the vehicle 105. As illustrated in FIG. 2D, the computer 110 can actuate a laser 160 to display a pattern on the road 200 indicating that an adjacent lane 202 to a current lane 202 of a vehicle 105 is provided for traffic in an opposing direction to the direction of travel of the vehicle 105.

Further, the computer 110 could retrieve, based on a current location of the vehicle 105, historical traffic data for the location. The historical traffic data could use travel paths for previous vehicles at or near the location to specify a number of lanes 202 and/or directions of travel of lanes 202.

Further alternatively or additionally, the computer 110 could include instructions to determine a lane boundary 204 based on a width of the vehicle 105. For example, lane boundaries 204 could be specified with respect to one another on the left and right sides of a roadway 202 based at least in part on a width of the vehicle 105. The computer 110 could be programmed to project lane lines 206 from lasers 160 spaced apart from one another according to the width of the vehicle 105. The permissible spacing of the lane lines 206 could be limited by a typical width of lanes 202 in a jurisdiction and/or according to map data or the like specifying a width of lanes 206 at a location of the vehicle 105. Further, the spacing of the lane lines 206 could be according to the vehicle 105 adding a buffer or cushion distance to the vehicle 105 width. For example, if a vehicle 105 were two meters wide, the spacing of the lane lines 206 could be three meters apart.

### Example Process

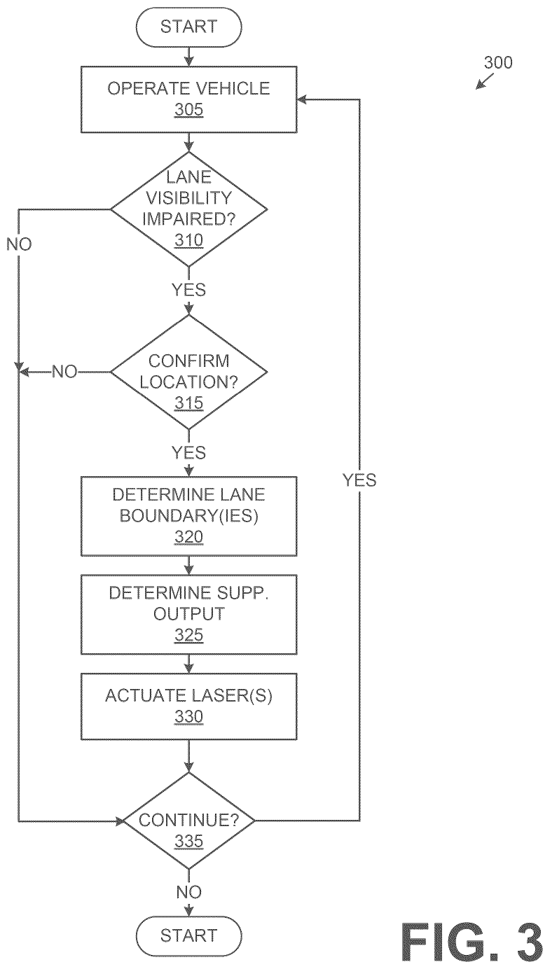

FIG. 3 is a diagram of an example process 300 for actuating lasers 160 to output lane indicating lines 206 and/or symbols 208 on a travel surface such as a road 200. The process 300 can be carried out according to instructions stored in a memory of, and executed by a processor of, a vehicle computer 110.

The process 300 begins in a block 305, in which a vehicle 105 is operated on a road 200 having at least one, and typically more, lanes 202, where the vehicle 105 is traveling in one of the lanes 202.

Next, in a block 310, the computer 110 determines whether lane visibility could be impaired for a human operator of the vehicle 105. This determination could be made in any suitable manner. For example, an operator could provide input via an HMI 150 to activate a lane line 206 display and/or to indicate that lane visibility is impaired. Alternatively or additionally the computer 110 could use data from one or more camera sensors 115, such as a camera 115 operating in the visible light spectrum, and could determine from such data that lane boundaries 204 are not visible. Yet further alternatively or additionally, an environmental sensor 115 such as a fog sensor 115 could indicate a condition in which lane visibility could be or is likely to be impaired for a human operator of the vehicle 105. If the determination of the block 310 is negative, then the process 300 proceeds to the block 335. If the determination of the block 310 is affirmative, then a block 315 is executed next.

In the block 315, the computer 110 determines whether the vehicle 105 location can be determined. If yes, then a block 320 is executed next period if not, then the process 300 proceeds to the block 335. Examples are possible in which the block 315 is omitted and/or the process 300 proceeds to the block 320 even if the vehicle 105 location cannot be confirmed. That is, as described further below, examples are possible in which laying boundaries are determined and lane lines 206 and/or symbols 208 are output even without a confirmation of the vehicle 105 location.

In the block 320, the computer 110 determines lane boundaries 204. For example, the computer 110 may use a suitable technique for determining lane boundaries 204 using thermal image data, as mentioned above. Further, lane boundaries 204 may be determined in combination with location data indicating a current geolocation of the vehicle 105 as mentioned above. Alternatively, if location data is not available, implementations are possible in which the computer 110 determines lane boundaries 204 solely from sensor 115 data such as thermal image data.

In the block 325, following the block 320, the computer 110 determines laser 160 output to supplement an operator's view of lane boundaries 204. That is, the computer 110 determines one or more lane lines 206 and/or one or more symbols 208 to be output on the road 200 surface. Example outputs are described above with respect to FIGS. 2A-2D. The computer 110 could include instructions to actuate laser output of lane lines 206 and/or symbols 208 in various configurations, and moreover the configurations could be determined by user input. In an example, the computer 110 could be programmed by default to output parallel lane lines 206 (see FIG. 2A), but a user could provide input via the HMI 150 to also display symbols 208, such as arrows indicating upcoming curves or turns (FIG. 2D). Many other examples are possible.

In the block 330, the computer 110 causes one or more lasers 160 to be actuated to output the lane line or lines 206 and/or symbol or symbols 208 determined in the block 325.

In the block 335, which may follow any of the blocks 310, 315, 330, it is determined whether the process 300 should continue. For example, an operator could deactivate he laser 160 output, a vehicle 105 could be powered down or could stop, etc. If the process 300 is to continue, the process returns to the block 305. Otherwise, the process 300 ends following the block 335.

### Concluding Remarks

Systems and methods described herein may be modified and/or omitted depending on the context, situation, and applicable laws, rules, and regulations. Further, regardless of actions that may be taken by a vehicle such as a computer controlling a vehicle, users should use good judgement and common sense when operating the vehicle. Operations described herein should always be implemented and/or performed in accordance with the owner manual and safety guidelines.

The computing devices discussed herein, including computer 110, include processors and memories. The memories generally including instructions executable by one or more of the computing devices'processors, such as instructions disclosed in the foregoing, and instructions for carrying out blocks or steps of processes described above. Computer executable instructions may be compiled or interpreted from computer programs created using a variety of programming languages and/or technologies, including, without limitation, and either alone or in combination, Java™, C, C++, Visual Basic, Java Script, Python, Perl, HTML, etc. In general, a processor (e.g., a microprocessor) receives instructions (e.g., from a memory, a computer readable medium, etc.), and executes these instructions, thereby causing one or more actions and/or processes to occur, including one or more of the processes described herein. Such instructions and other data may be stored and transmitted using a variety of computer readable media. A file in the computer 110 is generally a collection of data stored on a computer readable medium, such as a storage medium, a random access memory, etc.

A computer readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

With regard to the media, processes, systems, methods, etc., described herein, it should be understood that, although the steps of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in above description of processing, one or more of the steps could be omitted, or the steps could be executed in a different order than shown and described. In other words, the descriptions of systems and/or processes herein are provided for the purpose of illustrating certain embodiments and should in no way be construed so as to limit the disclosed subject matter.

“Based on” means based at least in part on unless explicitly stated otherwise. That is, the phrase “based on” encompasses being partly or entirely based on. Therefore, if A is “based on” B, this means that A could be entirely determined based on B, or could be determined based on B and some other factor or factors.

Accordingly, it is to be understood that the present disclosure, including the above description and the accompanying Figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise.

1. A system, comprising a processor and a memory, the memory storing instructions executable by the processor, including instructions to:
output a prediction, based on data from a sensor in a vehicle, that visibility of a lane boundary of a travel surface is impaired; and
in response to the prediction, actuate a laser to indicate the lane boundary on the travel surface.

2. The system of claim 1, wherein the instructions further include instructions to determine the lane boundary based on thermal image data.

3. The system of claim 1, wherein the instructions further include instructions to determine the lane boundary based on a determined width of a lane on the travel surface.

4. The system of claim 1, wherein the instructions further include instructions to determine the lane boundary based on a geo-location of the vehicle.

5. The system of claim 4, wherein the instructions to determine the lane boundary based on the geo-location of the vehicle include instructions to determine a number of lanes of the travel surface.

6. The system of claim 4, wherein the instructions to determine the lane boundary based on the geo-location of the vehicle include instructions to determine respective directions of travel of lanes of the travel surface.

7. The system of claim 4, wherein the instructions to determine the lane boundary based on the geo-location of the vehicle include instructions to determine the lane boundary based on historical traffic data for the location.

8. The system of claim 1, wherein the instructions further include instructions to determine the lane boundary based on a width of the vehicle.

9. The system of claim 1, wherein the data from a sensor in a vehicle is output from a fog sensor or a visible light spectrum camera.

10. The system of claim 1, wherein the instructions to actuate the laser include instructions to indicate a second lane boundary on the travel surface.

11. The system of claim 1, wherein the instructions to actuate the laser include instructions to indicate the lane boundary on the travel surface include projecting a symbol on the travel surface forward of the vehicle.

12. The system of claim 11, wherein the symbol indicates an upcoming curve of the travel surface, an object on the travel surface, or a recommended distance for the vehicle to follow a second vehicle.

13. The system of claim 1, wherein the laser is mounted to project light forward of the vehicle.

14. The system of claim 13, wherein a second laser is mounted to project light rearward of the vehicle, and the instructions further include instructions to actuate the second laser to indicate the lane boundary on the travel surface.

15. The system of claim 1, wherein the instructions to actuate the laser include instructions to output light detectable from a second vehicle.

16. A method, comprising:
outputting a prediction, based on data from a sensor in a vehicle, that visibility of a lane boundary of a travel surface is impaired; and
in response to the prediction, actuating a laser to indicate the lane boundary on the travel surface.

17. The method of claim 16, wherein the lane boundary is determined based on thermal image data, a determined width of a lane on the travel surface, a width of the vehicle, and/or a geo-location of the vehicle.

18. The method of claim 16, further comprising indicating a second lane boundary on the travel surface.

19. The method of claim 16, wherein indicating the lane boundary on the travel surface includes projecting a symbol on the travel surface forward of the vehicle.

20. The method of claim 16, further comprising actuating a second laser to indicate the lane boundary on the travel surface rearward of the vehicle.
